(19) United States
(12) Patent Application Publication
(10) Pub. No.: US 2008/0276508 A1
(43) Pub. Date: Nov. 13, 2008

(54) LIGHT EMITTING DIODE FOR ELECTRIC SIGNBOARD

(75) Inventor: Dae Hee LEE, Seoul (KR)

Correspondence Address: Jefferson IP Law, LLP, 1730 M Street, NW, Suite 807, Washington, DC, 20036, US

(73) Assignee: NEOVISION PNV CO., LTD., Seoul (KR)

(21) Appl. No.: 12/112,863

(22) Filed: Apr. 30, 2008

(30) Foreign Application Priority Data
May 7, 2007 (KR) 10-2007-0043929
Apr. 24, 2008 (KR) 10-2008-0038281

(51) Int. Cl. G09F 13/22

(52) U.S. Cl. 40/544

(57) ABSTRACT

Disclosed is a Light Emitting Diode (LED) for an electric signboard. The LED can prevent formation of shade caused by a coated silicon layer while minimizing the weight and thickness of the electric signboard. Further, the LED protects an internal LED chip by using a transparent hemispheric cap having scattering property, and a chip die is mounted on a Printed Circuit Board (PCB) while closely making contact with the surface of the PCB, so that thickness and weight of silicon coated on the surface of the PCB can be minimized.

### PRIORITY

This application claims the benefit under 35 U.S.C. §119(a) of Korean patent applications filed on May 7, 2007 in the Korean Intellectual Property Office and assigned Serial No. 10-2007-0043929, and filed on Apr. 24, 2008 in the Korean Intellectual Property Office and assigned Serial No. 10-2008-0038281, and the entire disclosures of each of which are hereby incorporated by reference.

### BACKGROUND OF THE INVENTION

1. Field of the Invention

The present invention relates to an electric signboard capable of displaying visual information such as characters or signs by using a plurality of Light Emitting Diodes (LEDs). More particularly, the present invention relates to an LED for an electric signboard, capable of preventing formation of shade caused by a coated silicon layer while minimizing the weight and thickness of the electric signboard.

2. Description of the Related Art

In general, an electric signboard is made by arranging a plurality of LEDs in an opened case in a matrix type, installing the case at a Printed Circuit Board (PCB), and then coating the PCB with silicon. Further, a driving module is installed at the rear surface of such a PCB to control an operation of the LEDs.

Hereinafter, the LED installed at the entire surface of the PCB will be described. The LED is classified into an outdoor LED, which is installed on a large-size electric signboard for outdoor use, and an indoor LED prepared in the form of a chip and installed on a small-size electric signboard for indoor use. Typically, in the outdoor LED, since a lead wire is soldered to the rear surface of a PCB by passing through the PCB, silicon is coated corresponding to a gap between the LED and the PCB. Thus, the PCB is thickened and becomes heavy.

Further, since the indoor chip LEDs are small and are directly mounted over the entire surface of the PCB, the irradiation surfaces of the chip LEDs are partially hidden due to surface tension of the silicon coated on the outer peripheral surface of the PCB. Thus, the shade may be formed or the brightness of the chip LEDs may be reduced.

### SUMMARY OF THE INVENTION

The present invention has been made to solve the above problems occurring in the prior art, and an object of the present invention is to solve problems of shade formation and brightness reduction that are caused when an irradiation surface of a chip LED is partially hidden due to surface tension of coated silicon while minimizing weight and thickness of an electric signboard at which LEDs are installed.

In order to accomplish the above object, the present invention mounts a die, on which a chip LED is installed, over the entire surface of a PCB and protects the chip LED by installing a transparent cap having a cylindrical body and hemispheric head portion.

Further, according to the present invention, both lead wires of an outdoor LED installed on a die are bent outward from the die such that the lead wires are exposed to an exterior, and bonding sections are formed at both ends of the exposed lead wire and mounted on a PCB while closely making contact with a surface of the PCB.

As described above, the present invention protects an internal light emitting device by using a transparent hemispheric cap having scattering property, and a chip die is mounted on a PCB while closely making contact with the surface of the PCB, so that thickness and weight of silicon coated on the surface of the PCB can be minimized.

Further, the present invention can prevent reduction in brightness or formation of shade that is caused when irradiation surfaces of the LEDs are partially hidden due to surface tension of the silicon coated on the outer peripheral surface of the PCB.

### BRIEF DESCRIPTION OF THE DRAWINGS

The above and other advantages of the present invention will become readily apparent with reference to the following detailed description when considered in conjunction with the accompanying drawings wherein:

FIG. 1 is a perspective view of an LED installed at an electric signboard according to an embodiment of the present invention;

FIG. 2 is a rear perspective view of the LED shown in FIG. 1;

FIG. 3 is a perspective view of an LED according to a second embodiment of the present invention;

FIG. 4 is a sectional view of an LED according to a second embodiment of the present invention;

FIG. 5 is a front view of a conventional electric signboard for indoor use;

FIG. 6 is a side view of the conventional electric signboard for indoor use shown in FIG. 5;

FIG. 7 is a sectional view of an LED for indoor use installed at the electric signboard shown in FIG. 5;

FIG. 8 is a rear perspective view of a conventional electric signboard for outdoor use;

FIG. 9 is a side view of the conventional electric signboard for indoor use shown in FIG. 8; and

FIG. 10 is a sectional view of an LED for indoor use installed at the electric signboard shown in FIG. 8.

Throughout the drawings, like reference numerals will be understood to refer to like parts, components and structures.

### DETAILED DESCRIPTION OF EXEMPLARY EMBODIMENT

Hereinafter, a preferred embodiment of the present invention will be explained in detail with reference to the accompanying drawings. In the following description of an operation principle about the preferred embodiment of the present invention, a detailed description of known functions and configurations incorporated herein will be omitted when it may make the subject matter of the present invention rather unclear.

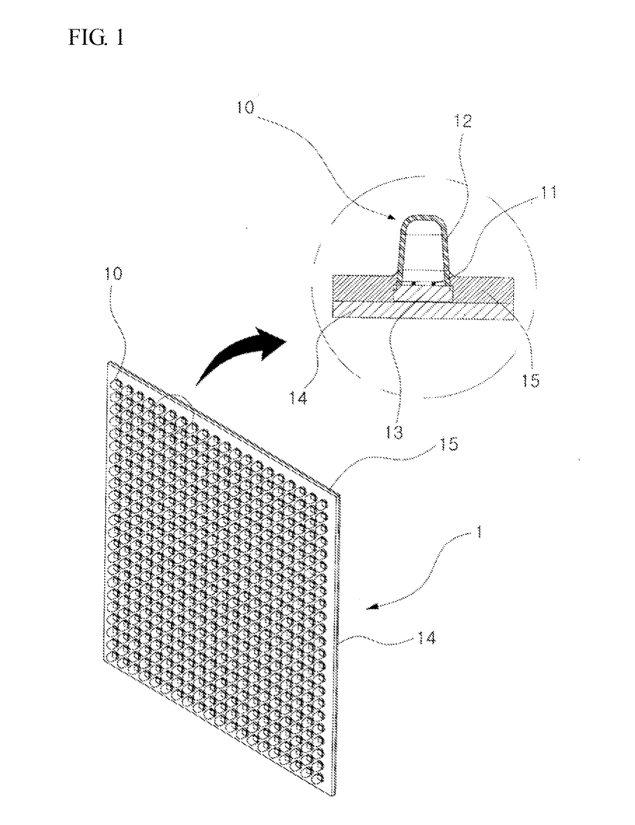

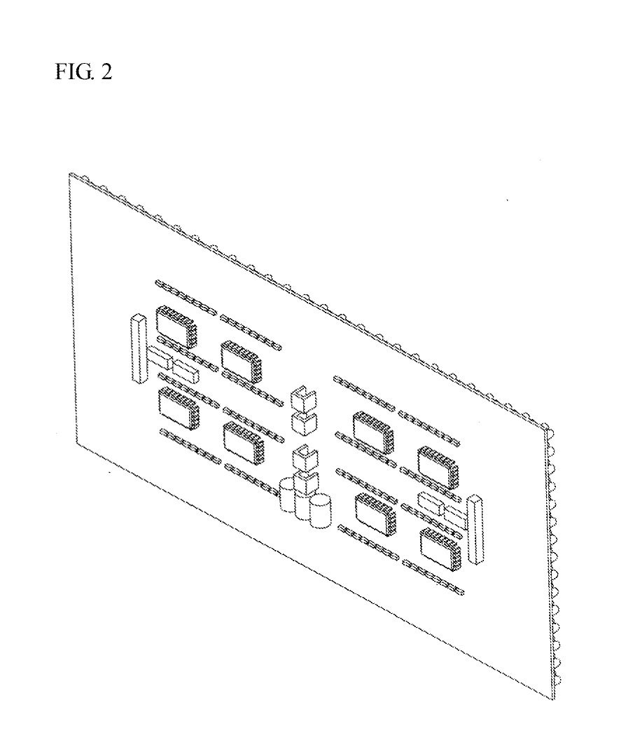

FIG. 1 is an enlarged sectional view of an LED installed at a PCB in an electric signboard that displays visual information according to the embodiment of the present invention.

As shown in FIG. 1, the electric signboard 1 is installed on a road or a stadium to display visual information through a plurality of LEDs 10.

Further, a chip die 13, in which one or more LED chip 11 is installed, is mounted on the PCB 14 of such an electric signboard 1. A driving module 2 is installed at the rear portion of the PCB 14 to operate the LED chip 11.

The chip die 13 mounted on the PCB 14 protects the LED chip 11 accommodated in the chip die 13 by using a transparent cap 12 that includes material having scattering property, and has a cylindrical body and a hemispheric head portion.

The body of the transparent cap 12 is a hollow cylindrical tube, the head portion of the body is closed by a hemispheric cover integrally formed with the body, and the body is coupled with the chip die 13 while surrounding the rim of the chip die 13 or the body is directly fixed to the chip die 13, so that the transparent cap 12 can protect the LED chip 11 provided in the transparent cap 12.

Further, the transparent cap 12 can be integrally formed with the chip die 13. According to another embodiment, the transparent cap 12 having various shapes is installed on the chip die 13 to protect the LED chip 11 provided in the transparent cap 12.

In addition, electric current is applied to the chip die 13 when the LED chip 11 is connected with the PCB 14. According to another embodiment, when a plurality of LED chips 11 is mounted on one chip die 13, the LED chips 11 are individually connected with the driving module such that the LED chips 11 can operate.

In detail, the LED chips 11 mounted on the chip die 13 is controlled by the driving module installed at the rear portion of the PCB 14, thereby emitting light having various colors and displaying information of a narrow pitch.

Moreover, a silicon layer 15 is coated over the entire surface of the PCB 14 to seal the outer peripheral surfaces of the chip die 13 and the transparent cap 12 while surrounding the outer peripheral surfaces thereof, thereby preventing external contaminant such as moisture or dust from being introduced into the inner side of the electric signboard. Thus, the driving module 2 and the LEDs 10 can be protected from the external contaminant.

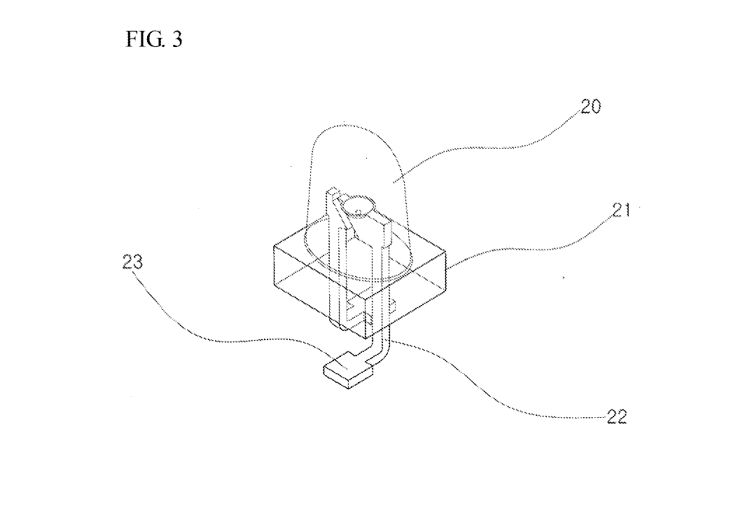

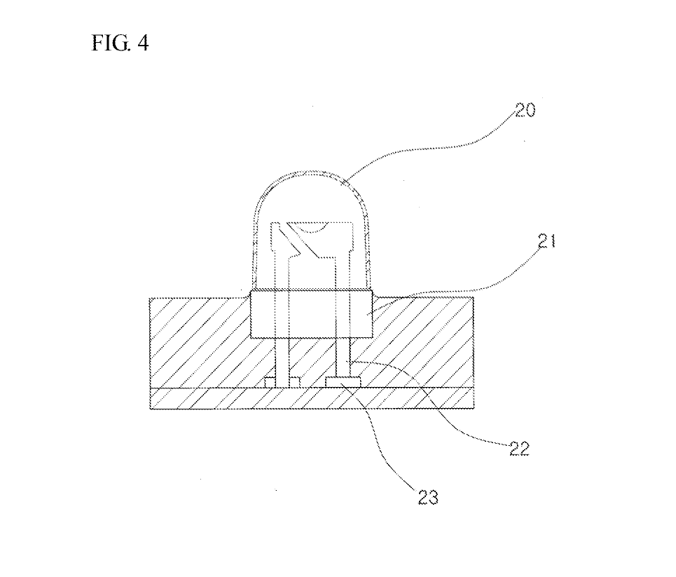

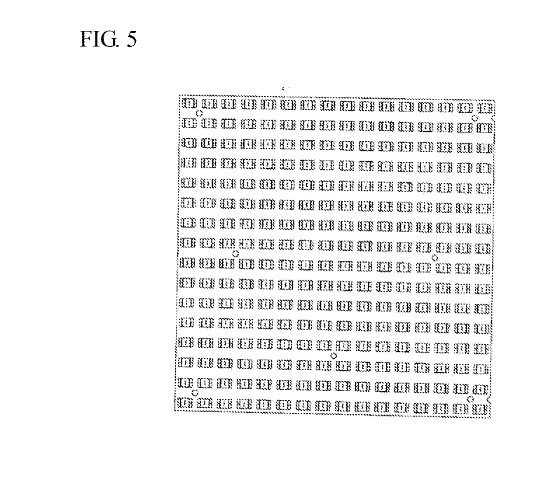

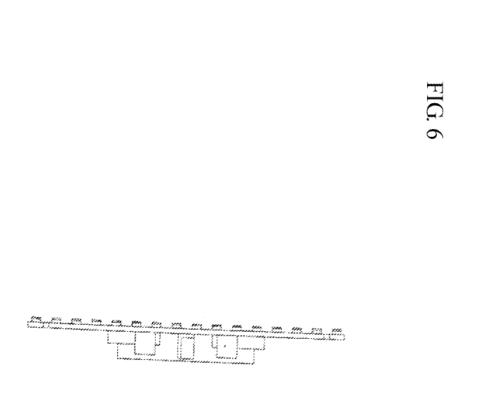

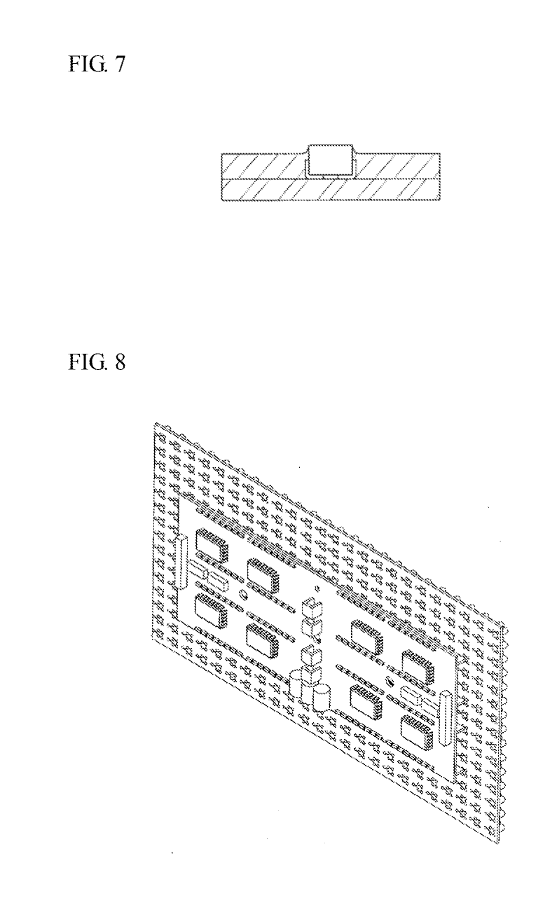

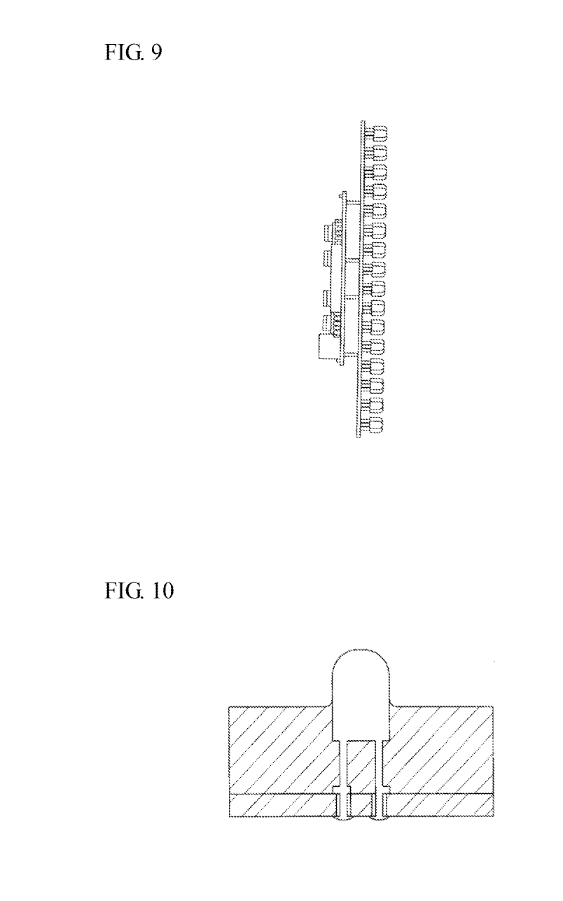

FIGS. 3 and 4 are perspective and sectional views illustrating an outdoor LED installed on an electric signboard according to a second embodiment of the present invention, respectively. As shown in FIGS. 3 and 4, both lead wires 22 of the outdoor LED, which is installed on a die 21, are bent outward by passing through the die 21 such that the lead wires 22 can be exposed. Each lead wire has a bonding section 23 at both ends thereof. The bonding section 23 is mounted on a PCB while closely making contact with the surface of the PCB.

Thus, the LED can be easily mounted on the surface of the PCB through the bonding sections 23. Further, since a driving module is installed at the rear portion of the PCB to control an operation of the LED, it is not necessary to install a driving module at an additional second PCB as in the case of a conventional electric signboard shown in FIG. 8. Consequently, the material cost can be saved.

Certain aspects of the present invention can also be embodied as computer readable code on a computer readable recording medium. A computer readable recording medium is any data storage device that can store data which can be thereafter read by a computer system. Examples of the computer readable recording medium include Read-Only Memory (ROM), Random-Access Memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An Light Emitting Diode (LED) for an electric signboard to display visual information, in which a plurality of LEDs are installed on a front surface of a printed circuit board of the electric signboard, silicon is coated on a peripheral surface of the printed circuit board and an operation of the LED is controlled by a driving module positioned at a rear surface of the printed circuit board, the LED comprising:
an LED chip which is protected by a transparent cap having scattering property and including a cylindrical body and a hemispheric head portion; and
a chip die for mounting the LED chip therein, in which the chip die is integrally formed with or assembled with the transparent cap and mounted over an entire surface of the printed circuit board.

2. The LED as claimed in claim 1, wherein a plurality of LED chips are mounted on the chip die.

3. An Light Emitting Diode (LED) for an electric signboard to display visual information, in which a plurality of LEDs are installed on a front surface of a printed circuit board of the electric signboard, silicon is coated on a peripheral surface of the printed circuit board and an operation of the LED is controlled by a driving module positioned at a rear surface of the printed circuit board, the LED comprising:
an outdoor LED installed on a die, in which both lead wires of the outdoor LED are bent outward from the die such that the lead wires are exposed to an exterior; and
bonding sections formed at both ends of the exposed lead wire and mounted on a PCB while closely making contact with a surface of the PCB.
